(19) United States
(12) Patent Application Publication
(10) Pub. No.: US 2009/0282989 A1
(43) Pub. Date: Nov. 19, 2009

(54) UNIVERSAL ROTISSERIE COOKING APPARATUS

(76) Inventor: Robert David Garnache, Seattle, WA (US)

Correspondence Address: Robert Garnache, 19519 Meridian Ave N, Seattle, WA, 98087, US

(21) Appl. No.: 12/467,287

(22) Filed: May 17, 2009

Related U.S. Application Data
(60) Provisional application No. 61/127,820, filed on May 16, 2008.

(51) Int. Cl. A47J 43/18

(52) U.S. Cl. 99/427

(57) ABSTRACT

A detachable, universal rotisserie device for use with an independent grilling apparatus. The rotisserie device includes a locking means for receiving an elongate support rod of the grilling apparatus, one or more support brackets, and one or more rotatable food retainers that are supported by the support bracket(s) and the elongate support rod. The locking means includes a clamping mechanism for securing the elongate support rod of the grilling apparatus to the detachable rotisserie device.

### CROSS REFERENCE TO RELATED APPLICATIONS

The present application claims the benefit of U.S. Provisional Application No. 61/127,820, filed May 16, 2008.

### FIELD OF THE INVENTION

The present invention relates to a portable, universal rotisserie cooking device for cooking a variety of foods including, but not limited to: ribs, steaks, burgers, fish, chicken parts, and vegetables. The universal rotisserie device is designed to lock and fit with the majority of market-available grilling devices (e.g., most gas and charcoal grills) having built-in or add-on rotisserie functionality.

### BACKGROUND OF THE INVENTION

Barbecuing has been and always will be a popular outdoor activity. Cooking with a rotisserie device is an ideal way to barbecue as it generally produces the most desired results of juicy, tender, flavorful food. The typical built-in rotisserie device is a grilling apparatus that is restricted to cooking larger food items, such as whole roasts, chickens and the like with no consideration to other smaller foods that would benefit from this style of cooking. Some of these smaller foods include, but are not limited to: ribs, steaks, burgers, chicken parts, fish, and vegetables.

Most modern rotisserie devices are only designed to fit their own particular manufacturer's cooking apparatus. Accordingly, their rotisserie shaft and supports are generally one solid, preconfigured unit that is not compatible with any other manufacturer's cooking apparatus. These rotisserie devices are not generally adjustable to fit multiple food retainer types (e.g., trays, racks, skewers, etc.) and they leave the average consumer with no feasible way to cook alternative food types without purchasing manufacturer-specific rotisserie add-on devices. These manufacturer-specific rotisserie add-ons devices are generally designed to only fit one barbeque or grilling machine manufacturer's product line.

U.S. Pat. Nos. 5,421,318 (Unrua), 5,431,093 (Dodgen), and 6,336,397 B1 (Piaget et al.), each show rotisserie devices having pivot brackets (spiders) that are secured in one position with no possible lateral adjustment. This lack of configurability makes it impossible to remove and reattach their rotisserie device to another cooking apparatus.

There remains a need for a portable, truly-universal rotisserie device that would fit any variety of barbeque or grilling device presently on the market. Further, it would be beneficial if this universal rotisserie included an easily-adjustable, multi-tray and/or multi-skewer system that would allow the average person to easily cook a variety of different foods types in a rotisserie fashion, utilizing indirect heat.

### SUMMARY OF THE INVENTION

In overcoming the above disadvantages associated with the prior art, a universal cooking apparatus made in accordance with the present invention includes, but is not limited to, a detachable rotisserie device for use with an independent heat source. The detachable rotisserie device includes: a universal locking means for receiving an elongate support rod of the independent heat source, one or more support bracket, and one or more rotatable food retainer supported by the one or more support bracket and the elongate support rod.

In accordance with another aspect of the invention, the universal locking means includes a clamping mechanism for securing a portion of the elongate support rod to the detachable rotisserie device.

In accordance with yet another aspect of the invention, the clamping mechanism includes a thumb screw.

In accordance with a further aspect of the invention, the detachable rotisserie device includes two support brackets and two clamping mechanisms for securing the detachable rotisserie device to the elongate support rod.

In accordance with yet a further aspect of the invention, the support bracket further comprises a pivot pin.

In accordance with another aspect of the invention, the pivot pin supports the rotatable food retainer such that the rotatable food retainer can rotate on the pivot pin.

In accordance with yet another aspect of the invention, the pivot pin is further configured to receive a skewer device.

In accordance with a further aspect of the invention, the detachable rotisserie has four rotatable food retainers that independently connect to the at least one support bracket.

In accordance with yet a further aspect of the invention, the rotatable food retainers rotate in a Ferris wheel fashion around an axis extending along the length-wise direction of the elongate support rod.

In accordance with another aspect of the invention, a portion of the plurality of rotatable food retainers are grilling trays having grilling vents.

In accordance with a further aspect of the invention, a portion of the rotatable food retainers are skewer devices having prongs that hold individual food items.

In accordance with yet a further aspect of the invention, is a universal rotisserie device for use with an independent grilling device, the universal rotisserie device includes: a clamping mechanism for securing the universal rotisserie device to an elongate support rod of the independent grilling device, one or more support brackets connected with the clamping mechanism, and multiple rotatable food retainers supported by the at least one support bracket and the elongate support rod.

In accordance with yet another aspect of the invention, is a rotisserie device for use with an independent cooking apparatus, the rotisserie device including: means for receiving an elongate support rod of the independent cooking apparatus, one or more support bracket connected with the means for receiving, and one or more rotatable food retainer supported by the at least one support bracket and the elongate support rod.

### DESCRIPTION OF THE DRAWINGS

Preferred and alternative examples of the present invention are described in detail below with reference to the following Figure drawings:

FIG. 1 illustrates a perspective view of a rotisserie device in accordance with an embodiment of the present invention;

FIG. 2 illustrates a perspective view of a rotisserie tray in accordance with an embodiment of the present invention;

FIG. 3 illustrates a perspective view of a rotisserie bracket in accordance with an embodiment of the present invention;

FIG. 4 illustrates a back-side perspective view of a rotisserie tray in accordance with an embodiment of the present invention; and

FIG. 5 illustrates a perspective view of a rotisserie skewer device in accordance with an embodiment of the present invention.

### DETAILED DESCRIPTION

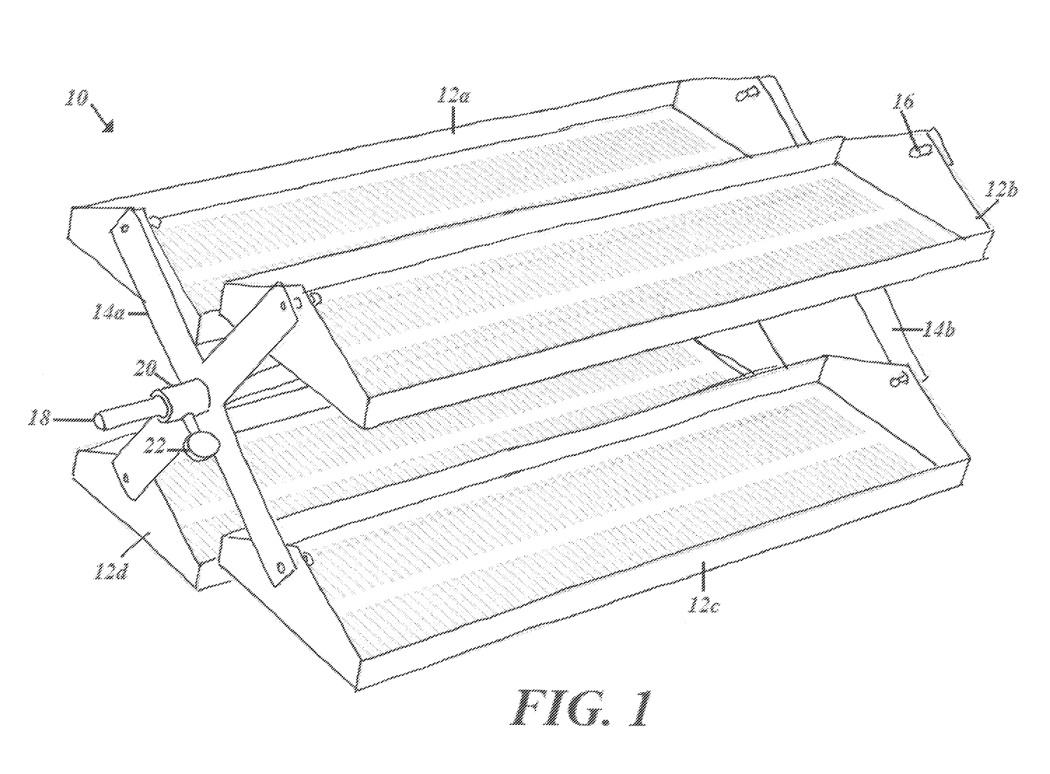

In accordance with an exemplary embodiment of the present invention, FIG. 1 illustrates a universal rotisserie device 10 that is portable and configurable to be used with any variety of market-available cooking devices, including but not limited to, most manufactured barbeques and grilling devices having existing rotisserie functionality. The universal rotisserie device 10 may include up to four grilling trays 12a-d and two support brackets 14a-b with pivot pins 16 and locking means including a receiving sleeve 20 and a clamping mechanism 22 (e.g., a thumb screw). The universal rotisserie device 10 may be connected to an external cooking apparatus's (not shown) built-in or add-on rotisserie unit (not shown) by being secured to an elongate support rod 18 of the external rotisserie unit.

The elongate support rod 18 is received through the receiving sleeve 20 and then locked with the universal rotisserie device 10 utilizing the clamping mechanism 22. In an embodiment, the universal rotisserie device 10 comprises two support brackets 14a-b which each have a receiving sleeve 20 and a clamping mechanism 22, such that the elongate support rod 18 can be locked to both opposing sides of the universal rotisserie device 10. In another embodiment, the universal rotisserie device 10 comprises only one support bracket 14a which locks with the elongate support rod 18 on only one side of the universal rotisserie device 10. It should be readily apparent to those skilled in the art that the clamping mechanism 20, 22 could include any common locking means, such as a screw, bolt, latch, ball and spring, notch-lock, etc., without departing from the spirit and scope of the present invention.

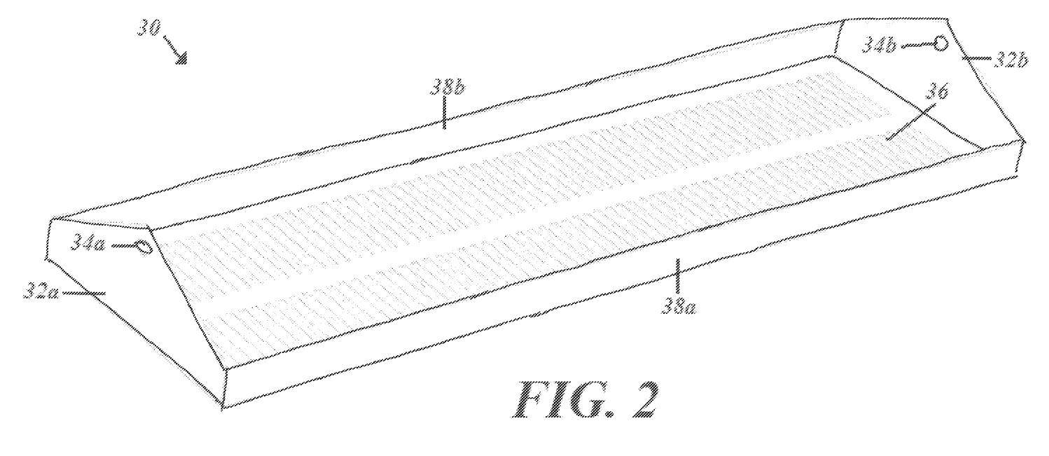

The support brackets 14a-b are plus-shaped (“+”) members having four pivot pins 16; one pivot pin 16 on each arm of the support brackets 14a-b. The arms of the support brackets 14a-b are generally of equal length. The pivot pins 16 may be ball shaped or notched at a peripheral end to securely hold the rotating grilling trays 12a-d to the universal rotisserie device 10 while it is rotating in a Ferris wheel fashion. In the Ferris wheel motion, the grilling trays 12a-d of the universal rotisserie device 10 act like the passenger gondolas of a Ferris wheel, such that the grilling trays 12a-d always maintain a the same vertical alignment with an external cooking apparatus. FIG. 2 illustrates a single grilling tray 30 having two sets of lateral sides. The single grilling tray 30 has a set of length-wise sides 38a-b and a set of width-wise sides 32a-b, which join at their edges with each other and with a vented grilling floor 36. In various embodiments, the vented grilling floor may have slots or holes to allow heat and smoke from a heat source to permeate the exterior of food being cooked within the grilling tray 30. The width-wise sides 32a-b of the grilling tray 30 may include a pin aperture 34a-b wherein the ball shaped end of pivot pins 16 may be inserted into to hold the rotating grilling tray 30 to the universal rotisserie device 10. In alternate embodiments, the pin apertures 34a-b might be disposed in the support brackets 14a-b (replacing the pivot pins 16), while the width-wise sides 32a-b of the grilling tray 30 includes the pivot pins 16 (replacing the pin apertures 34a-b) that attach into the apertures of the support brackets 14a-b. It would be understood to those skilled in the art that either arrangement performs a similar function.

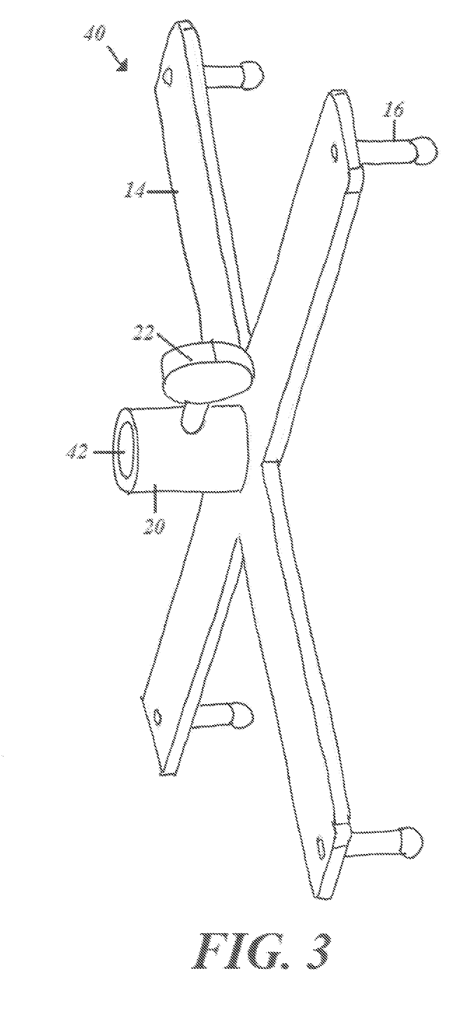

In accordance with an embodiment of the present invention, FIG. 3 illustrates a single support bracket arrangement 40 where each bracket 14 arm has a pivot pin 16 on the interior side of the bracket and a locking mechanism on the exterior side of the bracket 14. The bracket 40 may be welded to a receiving sleeve 20 having a hollow shape 42 to receive an elongate support rod 18 therein. In an alternate embodiment, the bracket 40 may comprise a threaded aperture (not shown). In this embodiment, the receiving sleeve 20 may have a matching threaded peripheral end (not shown) that can be removably screwed into the similarly-threaded portion of the bracket 40. This arrangement allows for multiple, different-sized sleeves 20 having different hollow shaped 42 diameters to be threaded into the bracket 40. The locking mechanism may also have a thumb screw 22 threaded into the receiving sleeve 20, such that is can be screwed down to compress any size elongate support rod 18 securely onto into the receiving sleeve 20.

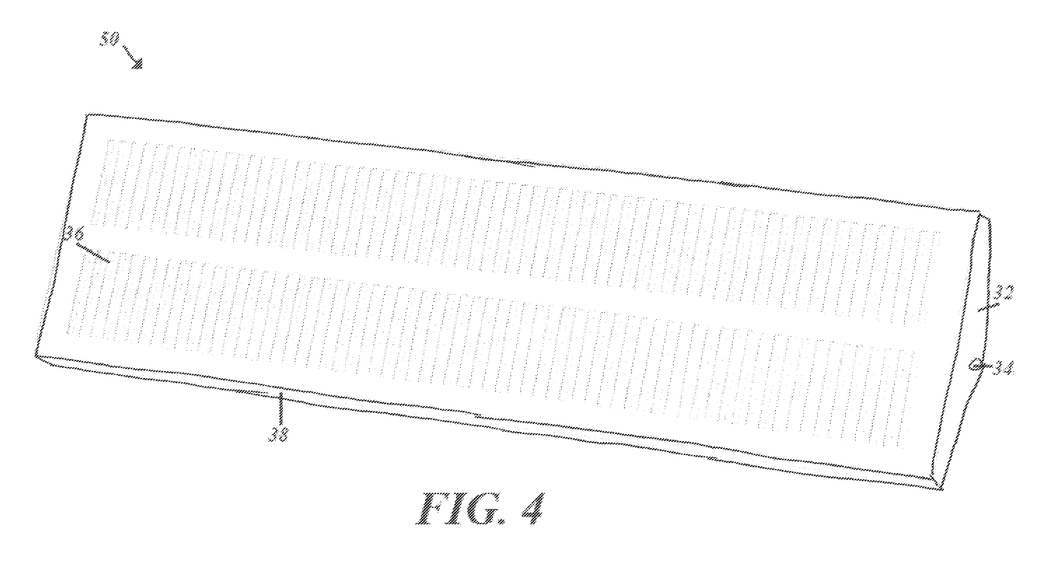

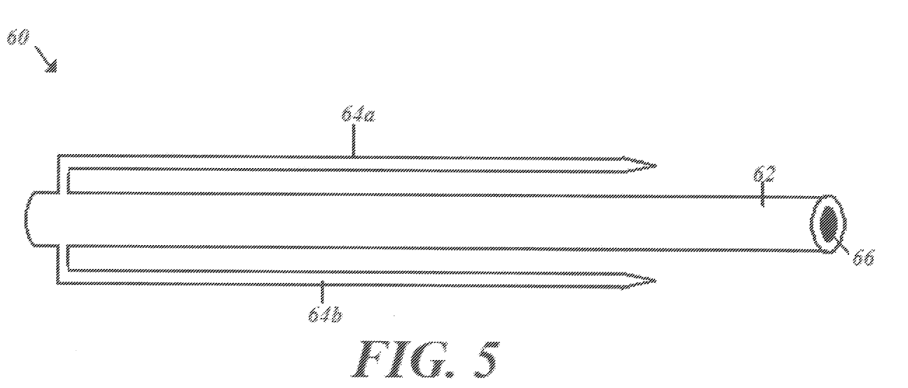

In an embodiment of the invention, FIG. 4 illustrates a back-side view of a grilling tray 50, depicting a plurality of slot-shaped grilling vents 36 arranged in two columns along the floor of the tray 50. The slots 36 are configured in such a way as to let smoke permeate the bottom side of the food being cooked in the grill, while at the same time giving the food a grilled searing in accordance with the shape of the slots. FIG. 5 illustrates a skewer device 60 that is configured to fit over the pivot pins 16 on one set of arms of the support brackets 14a-b in a similar fashion to the way the grilling trays are positioned across the universal rotisserie device 10. The skewer device 60 includes a central hollow shaft 62, having a hollow interior shape 66 that is configured to receive a pivot pin 16 at each end. In various embodiments, individual food items can be pierced and positioned along one of two prong components 64a-b.

In various embodiments, the universal rotisserie device 10 can be configured to include any arrangement of rotatable food retainer, including grilling trays 30, skewers 60, racks (not shown), etc., that can securely fit over a portion of the universal rotisserie device's 10 pivot pins 16.

The present invention provides a portable, universal rotisserie device having several inherent advantages, including: it is easy to assemble and requires only minutes to attach to any personal or professional cooking apparatus such as a barbecue grills, as well as it is easy to disassemble, store, and clean; the trays and support brackets are of such a predetermined size that they will fit any cooking apparatus, such as a barbecue or gas grill, and when attached to a rotisserie rod it will rotate without encountering obstructions inside the cooking apparatus fulfilling the aforementioned of being portable and universal; when it is attached to an external device's rotisserie rod, it allows all sorts of food to cook using the indirect heat method producing the most desirable and flavorful barbecuing method available; the trays can be easily disengaged from the support brackets without having to loosen or remove said support brackets making the transporting of food from one location to another more desirable, and it also provides the ease of cleaning said trays.

What makes cooking with the universal rotisserie device 10 of the present invention so desirable is that all foods are cooked with indirect heat, producing juicy, tender and flavorful and healthy foods, as opposed to cooking with direct heat on the grill surface, which can produce burnt, dried out, tough, carcinogenic food.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the invention in which an exclusive property or privilege is claimed are defined as follows:

1. A detachable rotisserie device for use with an independent heat source, the detachable rotisserie device comprising:
a universal locking means for receiving an elongate support rod;
at least one support bracket; and
at least one rotatable food retainer supported by the at least one support bracket and the elongate support rod,
wherein the elongate support rod is a component of the independent heat source.

2. The detachable rotisserie device of claim 1, wherein the universal locking means further comprises a clamping mechanism for securing a portion of the elongate support rod to the detachable rotisserie device.

3. The detachable rotisserie device of claim 2, wherein the clamping mechanism further comprises a thumb screw.

4. The detachable rotisserie device of claim 1, wherein the detachable rotisserie device comprises two support brackets and two clamping mechanisms for securing the detachable rotisserie device to the elongate support rod.

5. The detachable rotisserie device of claim 1, wherein the at least one support bracket further comprises a pivot pin.

6. The detachable rotisserie device of claim 5, wherein the pivot pin supports the rotatable food retainer such that the rotatable food retainer can rotate on the pivot pin.

7. The detachable rotisserie device of claim 5, wherein the pivot pin is further configured to receive a skewer device.

8. The detachable rotisserie device of claim 1, wherein the detachable rotisserie device further comprises a plurality of rotatable food retainers that independently connect to the at least one support bracket.

9. The detachable rotisserie device of claim 8, wherein the plurality of rotatable food retainers rotate in a Ferris wheel fashion around an axis extending along the length-wise direction of the elongate support rod.

10. The detachable rotisserie device of claim 8, wherein a portion of the plurality of rotatable food retainers are grilling trays.

11. The detachable rotisserie device of claim 10, wherein the grilling trays further comprise grilling vents.

12. The detachable rotisserie device of claim 8, wherein a portion of the plurality of rotatable food retainers are skewer devices.

13. The detachable rotisserie device of claim 12, wherein the skewer devices further comprise prongs that hold individual food items.

14. A universal rotisserie device for use with an independent grilling device, the universal rotisserie device comprising:
a clamping mechanism for securing the universal rotisserie device to an elongate support rod of the independent grilling device;
at least one support bracket connected with the clamping mechanism; and
a plurality of rotatable food retainers supported by the at least one support bracket and the elongate support rod.

15. The universal rotisserie device of claim 14, wherein the clamping mechanism further comprises a thumb screw

16. The universal rotisserie device of claim 14, wherein the plurality of rotatable food retainers rotate in a Ferris wheel fashion around an axis extending along the length-wise direction of the elongate support rod.

17. A rotisserie device for use with an independent cooking apparatus, the rotisserie device comprising:
a means for receiving an elongate support rod of the independent cooking apparatus;
at least one support bracket connected with the means for receiving; and
at least one rotatable food retainer supported by the at least one support bracket and the elongate support rod.

18. The rotisserie device of claim 17, wherein the means for receiving further comprises a clamping mechanism for securing a portion of the elongate support rod to the rotisserie device.

19. The rotisserie device of claim 17, wherein the rotisserie device further comprises a plurality of rotatable food retainers that independently connect to the at least one support bracket.

20. The rotisserie device of claim 19, wherein the plurality of rotatable food retainers rotate in a Ferris wheel fashion around an axis extending along the length-wise direction of the elongate support rod.
